(19) United States
(12) Patent Application Publication
(10) Pub. No.: US 2012/0034050 A1
(43) Pub. Date: Feb. 9, 2012

(54) PRODUCTION DEVICE AND PRODUCTION METHOD FOR BOOK-FORM PRINTED PRODUCT

(76) Inventors: Tadao Uno, Kanagawa (JP); Yosuke Uno, Kanagawa (JP)

(21) Appl. No.: 13/264,713

(22) PCT Filed: May 12, 2010
(86) PCT No.: PCT/JP2010/003220

§ 371 Date: Oct. 14, 2011

(30) Foreign Application Priority Data
May 14, 2009 (JP) 2009-118065

(51) Int. Cl. B42C 19/06; B32B 29/06; B42C 1/00

(52) U.S. Cl. 412/1; 412/13; 428/211.1

(57) ABSTRACT

A technology of producing a required number of copies of a plurality of kinds of book-form printed products automatically and continuously while a continuous paper material is being conveyed is provided. A production device for a book-form printed product, which continuously produces a plurality of kinds of book-form printed products from a continuous paper material, is provided with sheet cutting means which cuts paper into sheets constituting the book-form printed product, identification code reading means which reads an identification code describing at least identification information of the book-form printed product printed at least on any of the sheets, collector means which collects each sheet in accordance with the identification information of the book-form printed product indicated by the identification code, and stitcher means which stitches the collected sheets. By using the identification code, a production process of a book-form printed product required for each printed product can be performed from a continuous paper material without being restricted by the number of pages or size set in advance.

### TECHNICAL FIELD

The present invention relates to a production device and a production method for a printed product and particularly to a device and a method for continuously producing a plurality of kinds of book-form printed products from a continuous paper material.

### BACKGROUND ART

In a general method of producing a book-form printed product, single sheets, on each of which each page is printed, are overlapped with each other, folded, cut out in a finished size of the printed product after the back part is stitched, and completed by binding the sheets appropriately. For bookbinding in a large quantity, a system in which each process is configured into an integrated line so that operations from supply of sheet to completion of bookbinding can be performed is provided.

A technology of producing a printed product not by printing single sheet but cutting out a continuous paper material is also known. For example, in the technology of Patent Document 1, it is proposed that rolled paper is fed out and supplied and cut in the middle of the width direction, one of the cut rolled paper is folded so as to form the same row with the other cut rolled paper and printing is applied on each cut rolled paper and then, collated.

According to the technology of this document, a paged printed matter can be produced, and the printing sizes in the width and vertical directions are both made variable, and many kinds of paged printed matters can be produced inline continuously by a rotary press.

In Patent Document 2 which discloses a technology in which a book is produced similarly from continuous paper, a method is proposed in which a perforated transverse cutting line and a center vertical cutting line are made in a band-shaped paper material and a unit sheet is formed by dividing the paper from these cutting lines. In this technology, a primary sheet having perforation is divided into two parts at the center vertical cutting line so as to have secondary sheets, they are overlapped vertically, and the distal ends are shifted in the vertical direction and the secondary sheets are fed out so that vertically overlapped unit sheets are sequentially advanced, forward tension is given to each unit sheet located at the most distal end in the traveling direction, the sheets are sequentially cut off at the transverse cutting line and fed out, and after being glued, the unit sheets are sequentially overlapped and bonded per set number of sheets so as to form a book.

According to the technology of this document, a method of forming a book can be provided which can efficiently form books having several pages, even-number pages or the number of pages in which they are mixed, and random bookbinding is also possible.

Moreover, in Patent Document 3, a printed product manufacturing device is proposed in which a supply device which supplies a printing medium such as roll paper to a printing device, printing means which performs printing on the basis of printing information by digital data in the printing device, a forming device which forms the printing medium with predetermined shapes and dimensions, and conveying means which conveys the printing medium between each device are provided, and printed products are comprised by a plurality of kinds, and each printed product is sequentially produced in a predetermined number by two types or more each.

According to the technology of this document, printing on a printing medium is performed by digital printing and formed so as to have predetermined shape and dimensions so that the printed products attached to an optical disk are sequentially formed by a predetermined number each and the printed products can be formed rapidly and efficiently even in formation of many types and a small quantity of printed products.

### CITATION LIST

### Patent Literature

Patent Document 1: Japanese Unexamined Patent Application Publication No. 10-138450

Patent Document 2: Japanese Unexamined Patent Application Publication No. 2006-138450

Patent Document 3: Japanese Unexamined Patent Application Publication No. 2004-34392

### SUMMARY OF INVENTION

### Technical Problem

Each of the above Patent Documents is a method of producing different kinds of printed products using continuous paper and has an effect of using continuous paper that missing pages hardly occur as compared with use of single sheets and high-speed production is possible. On the other hand, since continuous paper is used, changes in the paper size or page number cannot be handled easily, which is a common problem.

In all the documents, the change in the size is handled by adapting the process in which a single sheet is cut out of the continuous paper in accordance with the size of the printed product. Also, in Patent Document 3, the printed products can be produced by a predetermined number each by alternately printing the contents of the plurality of kinds of printed products.

However, even in these technologies, printing of the plurality of kinds of printed products only in a desired number of copies and to switch to another kind of printed product at arbitrary timing cannot be performed. That is, in the technologies in Patent Documents 1 and 2, sheets to be fed into a line can be changed or different sizes of printed products can be handled by changing settings, but they should be all handled manually by workers. Also, in the technology in Patent Document 3, different kinds of printed products can be sequentially produced, but different kinds of printed products cannot be automatically produced only in a required number.

The present invention was made in view of the above prior-art problems and has an object to provide a technology of producing a plurality of kinds of book-form printed products in a required number automatically and continuously while a continuous paper material is conveyed.

### Solution to Problem

The present invention provides the production device for a book-form printed product as follows in order to solve the above problems.

That is, a production device for a book-form printed product, which continuously produces a plurality of kinds of book-form printed products from a continuous paper material, is provided with sheet cutting means which cuts paper into sheets constituting the book-form printed product, identification code reading means which reads an identification code describing at least identification information of the book-form printed product printed at least on any of the sheets, collector means which collects each sheet in accordance with the identification information of the book-form printed product indicated by the identification code, and stitcher means which stitches the collected sheets.

By using the identification code as above, a producing process of the book-form printed product can be performed for each printed product from a continuous paper material without limitation of the number of pages or size set in advance.

Here, it may be so configured that the identification code includes size information indicating the size or the position of at least either of a beginning end of each sheet and a terminal end of each sheet, the identification code reading means reads the size information, and the sheet cutting means cuts each sheet in accordance with the size information.

Also, it may be so configured that the identification code includes page number information of at least either the first page or the last page in page number information in the book-form printed product and the collector means collects sheets on the basis of the page number information read by the identification code reading means.

Also, in the configuration in which the book-form printed product is glue-bound in the production device for a book-form printed product, it may be so configured that the identification code includes page number information in the book-form printed product, the identification code reading means reads page number information, glue application determining means which determines sheets requiring application of a glue in accordance with the page number information and glue applying means which applies glue to a sheet region of an application target of the paper material before being cut in accordance with the determination result are provided, and the stitcher means performs at least glue-binding by applied glue.

Also, in the above production device for a book-form printed product, it may be so configured that the identification code includes finished size information of the book-form printed product and the identification code reading means reads the finished size information, and trimmer means which cuts out a sheet in a stitched state in accordance with the finished size information is provided.

In the above production device for a book-form printed product, former folding means which folds the continuous paper material at a predetermined position before being cut into a sheet at the latest may be provided.

Moreover, page opening means which opens the paper material again folded by this former folding means and quire forming means which folds the paper along the folding line made by the former folding after the collector means collects the sheets may be provided.

Also, in the production device for a book-form printed product described above, printing means which prints a printing surface including the identification code while the continuous paper material is being conveyed may be provided.

The present invention can also provide a production method for a book-form printed product as follows in order to solve the above problems.

That is, a production method for a book-form printed product which continuously produces a plurality of kinds of book-form printed products from a continuous paper material has at least a sheet cutting process of cutting the paper into sheets constituting the book-form printed product, an identification code reading process of reading an identification code describing at least identification information of the book-form printed product printed on the sheet, a collector process of collecting the sheets in accordance with the identification information of the book-form printed product indicated by the identification code, and a stitcher process of stitching the collected sheets.

Here, it may be so configured that the identification code includes size information indicating the size of each sheet or the position of at least either of a beginning end and a terminal end of each sheet, and the sheet is cut out in accordance with the size information in the sheet cutting process after the size information reading process.

Also, it may be so configured that the identification code includes page number information of at least either the first page or the last page in page number information in the book-form printed product, the page number information reading process is executed prior to the collector process, and the sheets are collected in the collector process.

Also, in the configuration in which the book-form printed product is glue-bound in the production method for a book-form printed product, it may be so configured that the identification code includes page number information in the book-form printed product, and a glue-binding process is executed after the page number information reading process.

In the glue-binding process, the sheets requiring application of a glue are determined in accordance with the page number information and glue is applied to a sheet region of an application target of the paper material before being cut in accordance with the result.

Also, it may be so configured that the identification code includes finished size information of the book-form printed product, and a finished size information reading process and a trimmer process of cutting out a sheet in a stitched state in accordance with the finished size information are provided after the stitcher process.

Also, a former folding process of folding the continuous paper material at a predetermined position before the sheet cutting process at the latest may be provided.

Moreover, a page opening process of opening the paper material again which was folded in the former folding process may be provided and also, a quire folding process of folding the paper along the folding line by the former folding after the collector means collects the sheets may be provided.

Also, a printing process of printing a printing surface including the identification code while the continuous paper material is being conveyed may be executed prior to the sheet cutting process.

The present invention can also provide a continuous paper material used in the production device and the production method for a book-form printed product.

That is, a continuous paper material used for continuous production of the plurality of kinds of book-form printed products is provided, in which a printing surface is provided at least on one side of which the contents of the plurality of kinds of the book-form printed products are printed, the identification code including identification information of the book-form printed product is described in a machine-readable manner at least on either of the vicinity of the same face as the contents and the vicinity of the back face, and the kind of the book-form printed product can be discriminated by reading the identification code.

### Advantageous Effects of Invention

The present invention exerts the following advantageous effects by having the above configurations.

That is, by producing the book-form printed product from the continuous paper material, high speed and continuous production is realized, and contribution can be made to highly accurate production with few missing pages or little incorrect collating.

By printing the identification code on each sheet in advance, processing according to the kind of the printed product can be performed in each stage of the sheet cutting means/sheet cutting process, the collector means/collector process, the stitcher means/stitcher process and the like, and flexible production of the book-form printed products can be realized. According to the present invention, even if the size or contents of the book-form printed product are changed, the book-form printed product can be produced automatically in accordance with the contents printed on the continuous paper material without involvement of workers.

### BRIEF DESCRIPTION OF DRAWINGS

FIG. 1 are configuration diagrams (Example 1) of a production device for a book-form printed product according to the present invention.

FIG. 2 are diagrams for explaining a production process of a printed product in the present invention.

FIG. 3 is a diagram for explaining a description mode of an identification code in the present invention.

FIG. 4 is a configuration diagram of a system which inspects the printed product using the identification code.

FIG. 5 are configuration diagrams (Example 2) of the production device for a book-form printed product according to the present invention.

FIG. 6 are diagrams (Example 3) for explaining the production process of the printed product in the present invention.

### DESCRIPTION OF EMBODIMENTS

Embodiments of the present invention will be described below on the basis of examples illustrated in the figures. The embodiments are not limited to those described below.

First, in Example 1, a device which produces a printed product by supplying roll paper on which contents of a plurality of kinds of book-form printed products (hereinafter referred to as printed products) are printed in advance and a production method thereof will be described. In Example 1, a production method of a printed product using an identification code will be described in detail.

In Example 2, in addition to the configuration of Example 1, a device which produces a printed product by using a digital printing unit while printing is performed by supplying unprinted roll paper and a production method thereof will be described.

### EXAMPLE 1

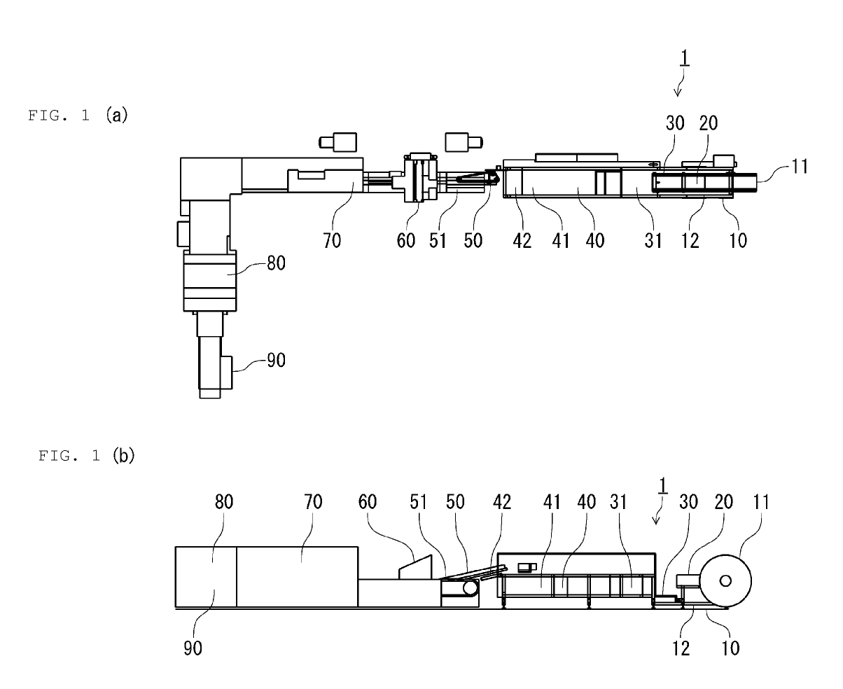

FIG. 1 are a plan view (FIG. 1A) and a front view (FIG. 1B) of a production device for a book-form printed product (hereinafter referred to as this device) according to the present invention. In a sheet supply section (10) of this device (1), roll paper (11) is disposed on a roll stand and the sheet is supplied to the left side in the figure on a conveyor (12).

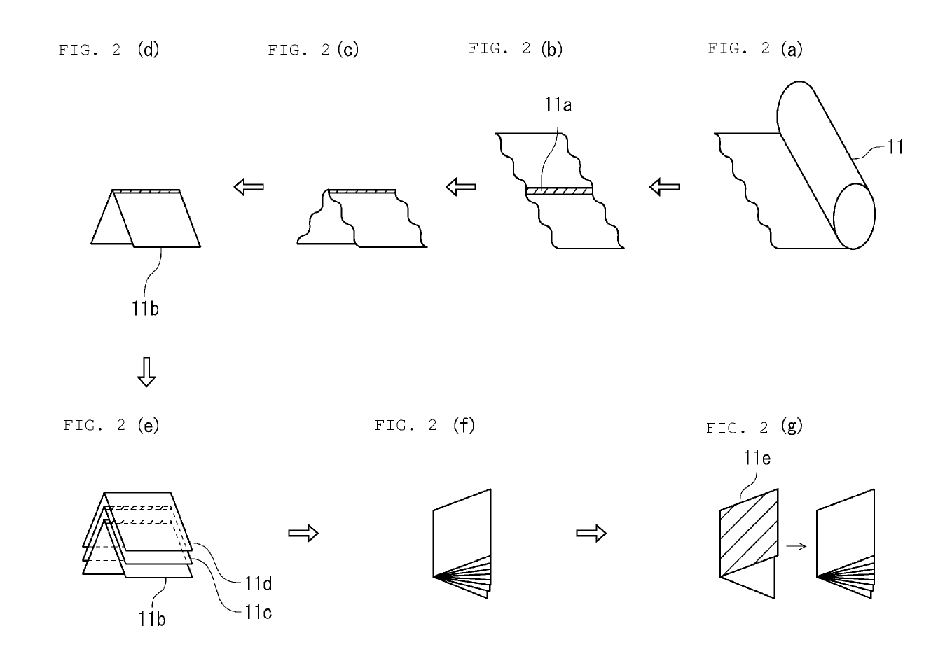

FIG. 2 are diagrams for explaining a production process of a printed product by this production method, in which FIG. 2A illustrates a state in which paper is fed out of the roll paper.

On the roll paper fed out of the roll stand, first, glue is applied by a gluing device (20) to a region corresponding to a glue-bound portion of the printed product (glue application process).

In the gluing device (20) of this example, a method of spraying glue onto the conveyed roll paper by a nozzle is used.

As illustrated in FIG. 2B, the glue (11a) is applied in the band shape on the surface of the still continuous roll paper.

Subsequently, the roll paper is folded in halves at the center in the width direction in a former folding device (30).

As illustrated in FIG. 2C, the applied glue corresponds to this folded portion (former folding process).

In the present invention, the above glue application process and the former folding process are not indispensable but can be arbitrarily selected in accordance with the printed product to be produced or a stitching method.

Hitherto, the glue has been applied immediately before stitching in the case of glue-binding, but by performing the application process prior to the former folding process or the subsequent sheet cutting process as in the present invention, the glue is applied on a continuous plane and high speed and uniform application is realized. Regarding the glue application process, the application region can be changed by a configuration using the identification code of the present invention, and the configuration will be described later.

As illustrated in FIG. 2D, the roll paper is cut by a sheet cutter (31) into sheets constituting the printed product (sheet cutting process).

At this time, there are a method of cutting the paper to a sheet length set in advance and a method of cutting the paper to a sheet length designated for each sheet by using a cut mark in the sheet cutting process. In the former case, if the printed product has the A4 size, cutting may be performed every 307 mm, and if it has the B5 size, cutting may be performed every 267 mm. At this time, for finishing cutting in the last trimmer process, a margin portion of 10 mm is left.

On the other hand, if the cut mark is used, a cut mark which can be read in the sheet cutter (31) is given to each sheet, the image of the cut mark is recognized by a CCD sensor or the like, and cutting is performed at the position of the cut mark. Since such cutting technology of the roll paper is known, the description will be omitted.

Subsequently, the identification code reading process and the collector process, which are essential parts of the present invention, will be described.

In this example, the identification code reading means and the collector means are integrally constituted by three devices, that is, an overlapping device (40), a collector device (41), and a book taking-out device (42). An identification code sensor, which is an identification code reading means, not shown, is disposed over the conveyor (12) as any of these devices or another device.

A barcode or the like is preferably used as the identification code, but any mode such as predetermined signs, letters or patterns can be used. Visibility does not matter, either, as long as the code is machine readable.

In the simplest configuration, identification information indicating the last sheet of each printed product is described in the identification code so that the printed product can be discriminated from each other by obtaining the information using the identification code sensor. For example, it may be so configured that 3-bit information indicating “101” in the barcode is defined as the last sheet so that the sheet can be determined to be the last one of the printed product by having this information read.

In the overlapping device (40), each cut sheet is fed to the collector device (41), and the sheets are collected to the last sheet on the collector device (41) as illustrated in FIG. 2E. In this example, 1 to 25 sheets can be freely collected, and a completed printed product becomes a book having 4 to 100 pages. When the page determined to be the last page in the identification code sensor has been collected, the book taking-out device (42) takes it out.

By means of the above configuration, only the sheets constituting one copy of the printed product can be collected and taken out. Only by describing information indicating the last page of the printed product as the identification code, sheets with the different numbers for each printed product can be accurately collected, and production of diversified printed products is realized.

When the present invention is put into practice, not only the information of the last page is stored in the identification code but the identification code is preferably described in each sheet so that each page and each printed product can be discriminated.

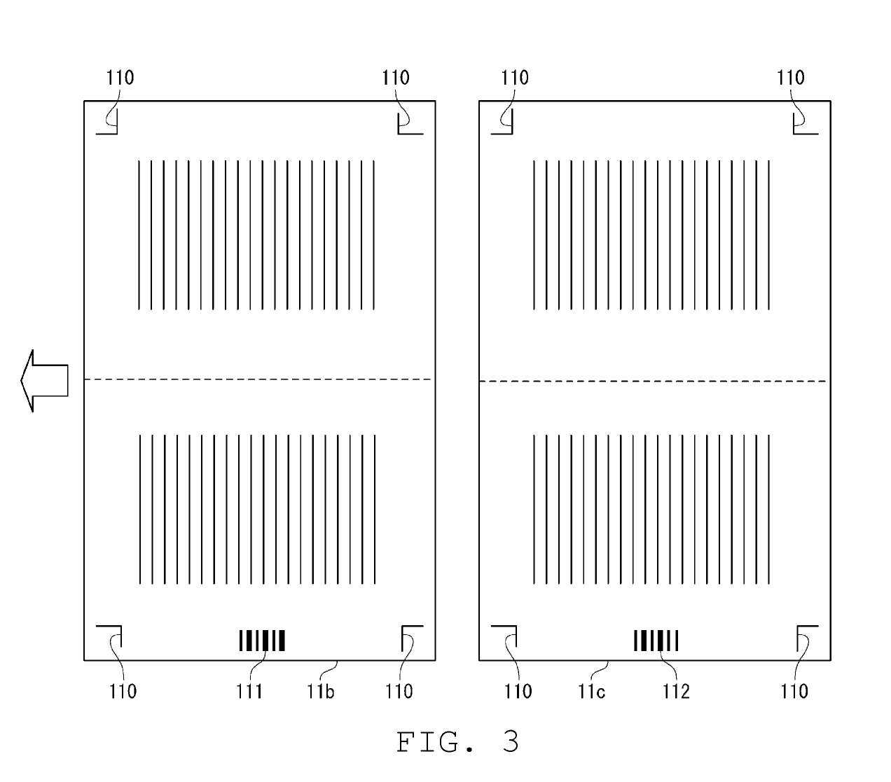

For example, barcodes (111) and (112), which are identification codes, are described in regions outside the frames of register marks (110) in each of the sheets (11b) and (11c) as illustrated in FIG. 3. This barcode includes information of page number and specific information of the printed product so that what number in which printed product can be discriminated.

According to this configuration, when sheets are overlapped in the overlapping device (40) or in the collector device (41), each sheet can be checked to see if there is any missing page or not. It becomes possible to sequentially collect the sheets from the first to the last of a printed product A to take them out as a book and then, to collect another sheets again from the first to the last of a printed product B. By printing the barcode at the same time as printing of the contents, missing print can be also detected by presence of the barcode, and a printed product without missing pages or incorrect collating can be produced.

The information to be included in the identification code can be changed as appropriate, and information only of the first sheet and the last sheet may be described, for example.

It may be so configured that the information of the number of sheets of the printed product is described in the first sheet and the collector device (41) counts the number of sheets sequentially from the subsequent sheet and inspects whether or not the identification code of the first sheet of the subsequent printed product is described after the predetermined number of sheets have been finished.

Also, it may be so configured that the specific information of the printed product can discriminate the preceding and subsequent printed products simply by 1-bit data of “0” and “1” in the sequence, or the specific information may include contents of the printed product such as JAN codes of books. Alternatively, the identification number of a customer who ordered the printed product or information of a client to which the printed product is to be sent may be included.

For the identification code, a method which can describe more information such as two-dimensional barcodes may be used. Also, information may be subjected to compression processing by a known method to be described and be subjected to decoding processing and read by a computer, not shown.

The printed product taken out of the book taking-out device (42) is fed by a feeding device (50) to a glue-binding device (51), which is the stitcher means and glue-bound in the gluing device (20) by using the applied glue (stitcher process).

As a result, as illustrated in FIG. 2F, one copy of the book is completed.

In this example, the following processes are further included in order to attach a cover and to cut the printed product into a finished size.

That is, in a cover feeder (60), a cover (11d) is attached as illustrated in FIG. 2G, and the cover is stitched by a wire stitcher (70) by using a wire. Moreover, in a trimmer (80), the sheet is cut out to a finished size on the basis of the register mark as illustrated in FIG. 3 (trimmer process).

Lastly, a completed printed product is discharged from a delivery device (90).

### ANOTHER EXAMPLE

A different embodiment in the production device for a book-form printed product in Example 1 will be described.

First, the roll paper is used in the above as the continuous paper material, but this is not limited, and a sheet in which perforation is formed in the width direction and folded, for example, may be used. If the size of the printed product is constant in the length direction, it may be so configured that the sheet cutting means cuts the sheets along the perforation.

The material of the printed product is not limited to paper, but a resin, a lumber, metal such as an aluminum foil, rubber or the like can be selected as appropriate.

Subsequently, a configuration of using an identification code in the gluing device (20) will be described. It may be so configured that an identification code sensor, which is the identification code reading means, is disposed in the gluing device (20) and control is executed such that the glue is not applied onto the sheet to be located on the outermost side according to the information.

In this configuration, glue application determining means of a computer, not shown, is provided in the gluing device (20) and determines from the page number of each sheet on what part in the printed product the current sheet is located when being overlapped. That is, if sheets are collected as in FIG. 2E, the glue is applied to the sheets (11b) and (11c), which come to the inner side, but the glue is not applied to the sheet (11d) on the outermost side.

Thus, during the period when the sheets (11b) and (11c) as application targets are being conveyed while the roll paper is being fed out of the paper supply section (10), the glue is injected from a nozzle, which is the glue applying means, and the injection is stopped while the sheet (11d) to which the glue is not applied is being conveyed. As described above, by intermittently applying the glue, the glue can be applied only to the necessary spots.

Moreover, it may be so configured that the identification code includes size information of the printed product so as to change the application position of the glue. An actuator, not shown, is provided in the glue applying means and made displaceable in the width direction, and the glue is applied in compliance with the position of a stitched part. For example, in the case of a printed product stitched at a position which is not the center in the width direction, it may be so configured that the length from the center to the stitched part (30 mm, for example) is included as displacement information in the identification code, and if this information is read by the identification code sensor, the nozzle is displaced by the actuator by 30 mm and the glue is applied to the position.

The configuration in which the identification code is used in the sheet cutting means will be described.

In the above example, the sheet cutter (31) performs the cutting process using the cut mark, but the identification code can include information of the cutting position. In this case, the identification code sensor, which is the identification code reading means, is disposed in the sheet cutter (31).

The identification code may store numerical value information such as information of the cut length (257 mm, 220 mm or the like), for example, or the cut length may be obtained on the basis of a comparison table between the sheet sizes and the cut lengths stored in a computer in advance including the information of the sheet sizes such as the A4 size, the B5 size and the like.

In accordance with the read-out cut length, the sheet cutting process is performed by the sheet cutter (31). As a result, the cutting position can be determined without using the cut mark, and printed products in various sizes can be handled.

Similarly to the sheet cutting means, the trimmer means can also perform cutting in accordance with the finished size by using the identification code. In this case, too, the identification code sensor is disposed in the trimmer means, and the finished size information is read out. Then, by performing cutting in accordance with the described finished size, contribution can be made to production of diversified printed products.

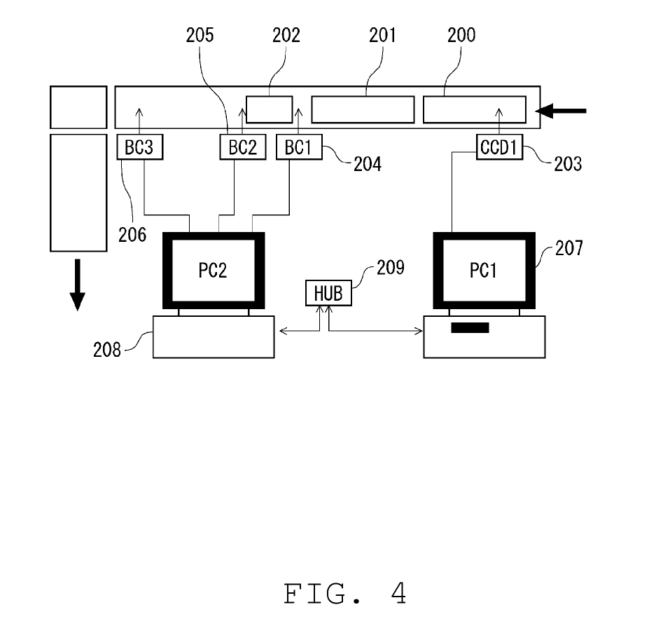

In the present invention, a production device for a printed product with higher accuracy can be provided by using the above identification code. FIG. 4 illustrates an explanatory diagram of an inspection system by the identification code.

Each of devices (200), (201), and (202) in the figure has each function from the sheet supply section (10) to the sheet cutter (31), from the overlapping device (40) to the glue-binding device (51), and to the cover feeder (60), respectively.

In the stage of the first device (200), the identification code printed on each sheet is read out by a CCD camera (203) regarding the printed product fed out from the roll paper and detection is made so as to see whether the sheets are aligned accurately in the descending order or there is no missing page, printing errors or the like. The CCD camera (203) is connected to a PC1 (207), and the PC1 stores the determination result of OK or NG for each book.

Personal information included in the identification code may be read out and listed at the same time.

Subsequently, the identification code on the surface of the book bound by the device (201) is read by a barcode reader BC1 (204), and whether the sheet is the second page or not is checked. Moreover, the identification code on the surface of the book to which the cover is attached by the device (202) is read by a barcode reader BC2 (205), and whether the sheet is the first page or not is checked. At this time, when this book passes by the BC2, the speed is adjusted so that the subsequent book does not reach the BC1, and if a defect is found, NG is recorded in a PC2 (208) regarding the book.

Moreover, a barcode reader BC3 (206) reads the personal information from the identification code, the information is checked with personal information read by the PC1 (207) connected through network by a hub (209), and whether the information matches the information before bookbinding is checked.

According to this configuration, whether the number of sheets constituting the printed product is appropriate or not in each stage and whether all the printed products have been produced can be accurately managed.

Since the region on which the identification code is described is cut off by the trimmer means in the last stage, the barcodes or the like are not left on the completed printed products, and appearance of the printed products is not damaged.

### EXAMPLE 2

A production device and a production method for producing a printed product while printing is applied on blank roll paper will be described as a second example of the present invention.

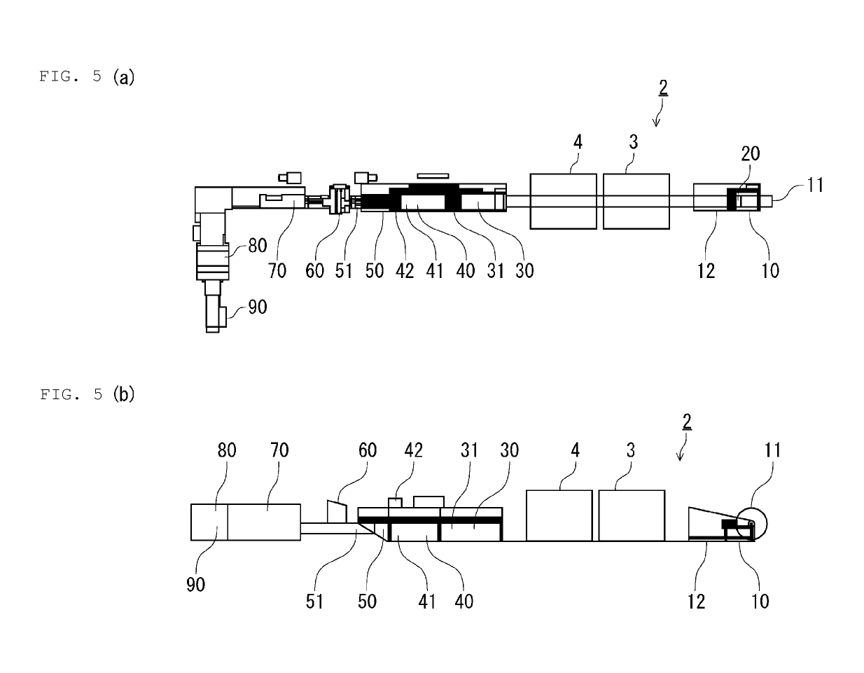

FIG. 5 are configuration diagrams of the entirety of the device (2), in which FIG. 5A is a plan view and FIG. 5B is a front view. The devices constituting the device (2) in common with those in Example 1 are given the same reference numerals, and the explanation will be omitted. The characteristics of this example is that two digital printing units (3) and (4) are disposed between the gluing device (20) and the former folding device (30).

That is, blank roll paper is supplied from the sheet supply section (10), and the glue is applied at the center by the gluing device (20) and then, printing is applied on the front face by a first digital printing unit (3) and on the back face by a subsequent digital printing unit (4), respectively.

To these digital printing units (3) and (4), a print manuscript created by an editing computer as known is fed, and printing is performed on the basis of the instruction. In the present invention, during this printing, the identification code is printed at the same time with the contents of the printed face so that the type or page number of the printed product can be identified.

According to this example, a book-form printed product can be automatically produced consistently by supplying blank roll paper, and it is even unnecessary to print on the roll paper in advance. Also, by using the digital printing units, printed products with different contents one by one can be easily produced, and contribution can be made to production of the printed products according to a distribution list. Moreover, by means of the present invention, printed products, each constituted by a different number of pages, can be continuously produced by combining required contents in accordance with the distribution list.

### EXAMPLE 3

A third example of the present invention will be described. The invention according to this example proposes a production method in which a part of the above processes is improved in order to handle printed products with various kinds of bookbinding.

In Example 1, as illustrated in FIG. 2, a paper material is fed out of roll paper (FIG. 2A), the glue (11a) is applied in the band shape, and former-folded (FIG. 2C). After that, the roll paper in the folded state is cut into sheets (FIG. 2D) and collected by the overlapping device (40) up to 25 sheets.

On the other hand, the invention according to this example is characterized in that, after the former folding process (2C), a process of opening the folded roll paper again is included. This method will be described below in detail.

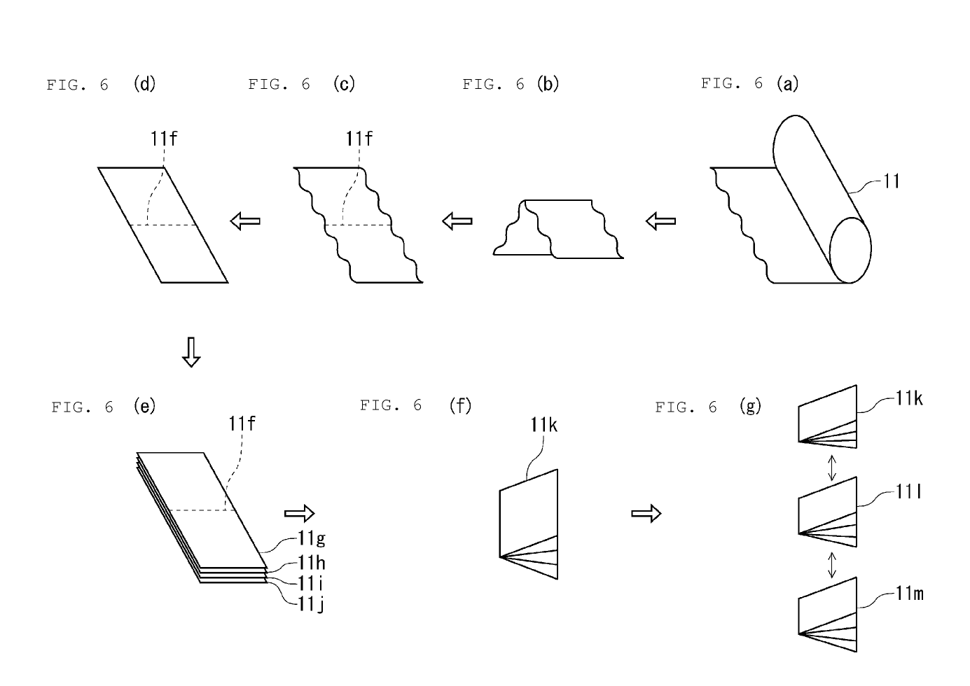

FIG. 6 are explanatory diagrams for explaining processes of the production method in this example. Similarly to Example 1, the state in which a paper material is fed out of the roll paper is illustrated in FIG. 6A. Then, as illustrated in FIG. 6B, the roll paper is folded in halves at the center in the width direction using the former folding device (30). Here, as in Example 1, the glue may be applied in the glue application process prior to the former folding process.

After the former folding, the page opening process of opening the folded portion again (FIG. 6C) is executed. Regarding the page opening process (FIG. 6C), a page opening function can be mounted on the former folding device (30) or a page opening device, not shown, maybe used. Alternatively, the sheet can be made to spontaneously open by introducing it in an open state into a conveying roller after being former-folded.

By means of the page opening process (FIG. 6C), the roll paper (11) having a folding line (11f) on the folded portion is created.

Subsequently, the roll paper is cut by the sheet cutter (31) into sheets (11g) constituting the printed product (sheet cutting process) (FIG. 6D). Similarly to Example 1, the paper may be cut to the sheet length set in advance or may be cut to the sheet length designated for each sheet using the cut mark in the sheet cutting process.

Before or after the sheet cutting process, the glue application process may be provided in order to apply the glue to the stitched part of the required sheets.

Then, the routine proceeds to the identification code reading process and the collector process, which are essential parts of the present invention. On the basis of the information read out in the identification code reading process, the overlapping device (40) feeds each of the cut sheets to the collector device (41), and the sheets are collected sequentially to the last sheet on the collector device (41) as illustrated in FIG. 6E. Here, a large difference from Example 1 is that the sheet taken out by the overlapping device (40) in this example is not in the folded state but a single sheet.

By opening the sheets again after former-folding as above, the taking-out work of each sheet by the overlapping device (40) is facilitated. Particularly, if the paper is thin, there has been a problem that the sheets in the folded state cannot be taken out easily. According to the present invention, regardless of the type of paper, high-speed production of printed products is possible, and contribution can be made to prevention of incorrect collating or the like.

The sheets (11g), (11h), (11i), and (11j) in the state with folding lines (11f) are collected by the collector device (41). If sheets are collected to the page determined to be the last page by the identification code sensor, the sheets are fed to the folding device (not shown), and they are folded again in the overlapped state so as to form a quire (11k) (folding process) (FIG. 6F).

At this time, since the folding line (11f) has been already given to each sheet, the sheets can be folded easily at the accurate position, and high-quality printed products can be produced.

Bookbinding can be completed by attaching a cover to the completed quire as necessary.

On the other hand, as illustrated in FIG. 6G, it may be so configured that a plurality of collated quires (11k), (11l), and (11m) are further overlapped and stitched by a wire, respectively, a glue is applied on the back and a cover is attached so as to bind a book in a side stitching manner.

According to the method illustrated in Example 3, since works can be performed with sheets in an unfolded state in each process of cutting, overlapping, and collecting, a glue applying work, which is difficult in the folded state, can be performed in an arbitrary process. Thus, similarly to the prior-art bookbinding processes, side stitching (including adhesive stitching) or saddle stitching can be flexibly handled, and a change in the number of pages or different bookbinding can be also flexibly handled.

Particularly, by performing bookbinding while accurately managing each sheet by using an identification code as in the present invention, a production method which has been impossible with the prior-art production device for a printed product such that book-form printed products having different sizes can be continuously produced, the number of pages can be varied, the stitching is changed in accordance with the number of pages or the like can be realized.

### REFERENCE SIGNS LIST

1 production device for a book-form printed product

10 sheet supply section

11 roll paper

12 conveyor

20 gluing device

30 former folding device

31 sheet cutter

40 overlapping device

41 collector device

42 book taking-out device

50 feeding device

51 glue-binding device

60 cover feeder

70 wire stitcher

80 trimmer

90 delivery device

1. A production device for a book-form printed product which continuously produces a plurality of kinds of book-form printed products from a continuous paper material, characterized in that
an identification code which includes identification information of at least the book-form printed product and at least either of numerical value information relating to the size of sheets constituting the book-form printed product or sheet size information of each sheet is described on the continuous paper material, comprising at least:
identification code reading means which reads the identification code;
sheet cutting means which calculates a cutting position from the read-out numerical value information or obtains the cutting position from a comparison table of the sheet size and cut length provided in advance from the sheet size information and cuts the sheets constituting the book-form printed product;
collector means which collects each sheet in accordance with the identification information of the book-form printed product indicated by the identification code; and
stitcher means which stitches the collected sheets.

2. The production device for a book-form printed product according to claim 1, further comprising:
a former folding means which folds the continuous paper material at a predetermined position before cutting the same into each sheet at the latest.

3. The production device for a book-form printed product according to claim 1, wherein
the identification code includes page number information of at least the first page or the last page in page number information in the book-form printed product; and
the collector means collects sheets on the basis of the page number information read by the identification code reading means.

4. The production device for a book-form printed product according to any one of claim 1, in the configuration of glue-binding of the book-form printed product, wherein
the identification code includes page number information in the book-form printed product, the identification code reading means reads the page number information;
glue application determining means which determines sheets requiring application of a glue in accordance with the page number information and glue applying means which applies glue to a sheet region of an application target of the paper material before being cut in accordance with the determination result are provided; and
the stitcher means performs at least glue-binding by applied glue.

5. The production device for a book-form printed product according to any one of claim 1, wherein
the identification code includes finished size information of the book-form printed product;
the identification code reading means reads the finished size information; and
trimmer means which cuts out a sheet in a stitched state in accordance with the finished size information is provided.

6. The production device for a book-form printed product according to any one of claim 2, comprising:
page opening means which opens the paper material folded by the former folding means; and
quire forming means which folds the paper along the folding line made by the former folding after the collector means collects the sheets.

7. The production device for a book-form printed product according to any one of claim 1, further comprising:
printing means which prints a printing surface including the identification code while the continuous paper material is being conveyed.

8. A production method for a book-form printed product which continuously produces a plurality of kinds of book-form printed products from a continuous paper material, characterized in that
an identification code which includes identification information of at least the book-form printed product and at least either of numerical value information relating to the size of sheets constituting the book-form printed product or sheet size information of each sheet is described on the continuous paper material, comprising at least:
identification code reading process of reading the identification code;
sheet cutting process of calculating a cutting position from the read-out numerical value information or obtaining the cutting position from a comparison table of the sheet size and cut length provided in advance from the sheet size information and cutting the sheets constituting the book-form printed product;
a collector process of collecting the sheets in accordance with the identification information of the book-form printed product indicated by the identification code; and
a stitcher process of stitching the collected sheets.

9. The production method for a book-form printed product according to claim 8, further comprising:
a former folding process of folding the continuous paper material at a predetermined position before the sheet cutting process at the latest;
a page opening process of opening the paper material again which was folded in the former folding process; and
a quire folding process of folding the paper along the folding line made by the former folding after the collector means collects the sheets.

10. A continuous paper material used in continuous production of a plurality of kinds of book-form printed products, characterized in that
a printing surface is provided at least on one side of which the contents of the plurality of kinds of the book-form printed products are printed;
an identification code including identification information of the book-form printed product and at least either of numerical value information relating to the size of sheets constituting the book-form printed product or sheet size information of each sheet is described at least on either of the vicinity of the same face as the contents or the vicinity of the back face in a machine readable mode; and
the kind of the book-form printed product can be discriminated by reading the identification code.

11. (canceled)
